(19) United States
(12) Patent Application Publication
(10) Pub. No.: US 2026/0154597 A1
(43) Pub. Date: Jun. 4, 2026

(54) Gate Motional Excitation Characterization and Reduction

(71) Applicant: IonQ, Inc., College Park, MD (US)

(72) Inventors: Peter Lukas Wilhelm MAUNZ, Albuquerque, NM (US); Ismail Volkan INLEK, Kensington, MD (US); Jwo-Sy CHEN, Greenbelt, MD (US); Matthew EBERT, Madison, WI (US)

(21) Appl. No.: 18/941,980

(22) Filed: Nov. 8, 2024

Related U.S. Application Data
(60) Provisional application No. 63/597,998, filed on Nov. 10, 2023.

(51) Int. Cl. G06N 10/70; G06N 10/40

(52) U.S. Cl. CPC G06N 10/70; G06N 10/40

(57) ABSTRACT

Disclosed herein are systems and methods for minimizing error accumulation in a quantum circuit. A method may include for at least one respective gate in the quantum circuit: generating a random phase value; setting a phase attribute of a respective laser pulse to the random phase value, wherein the respective laser pulse is associated with the respective gate; and applying the respective laser pulse to at least one trapped ion representing a qubit of the quantum circuit.

### CLAIM OF PRIORITY

The present application claims priority to U.S. Provisional Application No. 63/597,998, filed on Nov. 10, 2023, which is hereby incorporated herein by reference.

### TECHNICAL FIELD

Aspects of the present disclosure relate generally to systems and methods for use in the implementation, operation, and/or use of quantum information processing (QIP) systems.

### BACKGROUND

Two-qubit gates in trapped ion systems are mediated by one or multiple motional modes of a chain of ions. The objective of the gate action is to apply forces to the two ions participating in the gate that move the distribution in phase space in a way that once the gate is complete, the mode is returned to the same phase space location it started at. This is usually called phase space closure.

However, when a gate implementation is not perfect, the loop in phase space does not get fully closed and the phase space distribution at the end of the gate differs from the one at the beginning. This leads to a gate error.

If multiple gates are realized consecutively, the delay between gates or the phase of the gate beams determines the direction of the motion in phase space. As each gate fails to achieve phase space closure, the error accumulates. There thus exists a need to reduce the amount of error accumulation caused when realizing multiple gates consecutively.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method for minimizing error accumulation in a quantum circuit, the method including: for at least one respective gate in the quantum circuit: generating a random phase value; setting a phase attribute of a respective laser pulse to the random phase value, wherein the respective laser pulse is associated with the at least one respective gate; and applying the respective laser pulse to at least one trapped ion representing a qubit of the quantum circuit.

In some aspects, the techniques described herein relate to a method, wherein a first random phase value is set as a phase attribute of the respective laser pulse for a first gate of the quantum circuit and a second random phase value is set as a phase attribute of another respective laser pulse for a second gate of the quantum circuit.

In some aspects, the techniques described herein relate to a method, further including: applying the respective laser pulse to the at least one trapped ion when executing the first gate; and applying the another respective laser pulse to the at least one trapped ion when executing the second gate.

In some aspects, the techniques described herein relate to a method, wherein the first random phase value is different from the second random phase value.

In some aspects, the techniques described herein relate to a method, wherein the respective gate is a two-qubit gate.

In some aspects, the techniques described herein relate to a method, wherein the random phase value is within a threshold phase boundary.

In some aspects, the techniques described herein relate to a method for minimizing error accumulation in a quantum circuit, the method including: executing a first gate of the quantum circuit; for at least one subsequent gate in the quantum circuit: generating a random time delay value; waiting for the random time delay to elapse; and applying a laser pulse of the subsequent gate to at least one trapped ion representing a qubit of the quantum circuit.

In some aspects, the techniques described herein relate to a method, wherein the random time delay value is within a threshold time delay boundary.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates phase diagrams illustrating residual motional excitation.

FIG. 5 illustrates a QIP system executing a phase randomization module and a delay randomization module.

FIG. 6 illustrates phase diagrams illustrating residual motional excitation after applying phase randomization and/or delay randomization.

FIG. 7 illustrates a method for minimizing error accumulation associated with residual motional excitation in a quantum circuit.

FIG. 8 illustrates a method for minimizing error accumulation associated with residual motional excitation in a quantum circuit using time delay(s).

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

As noted above, aspects of the present disclosure relate to gate motional excitation characterization and reduction. As noted above, two-qubit gates in trapped ion systems are mediated by one or multiple motional modes of a chain of ions

There are two cases in which alignment of the motional phase between gates can be used. In the first case, when characterizing the effect of the gate on the motional state, the residual action on the motional state may be characterized with an amplified signal if the actions of consecutive gates add up. This can be achieved by aligning the phases accordingly.

In the second case, when executing quantum circuits, accidental alignment of these residual motional deviations amplifies gate errors. Thus, in this case a random or deliberate choice of the phase can help minimize the residual accumulated action on the motional mode and keep the motional mode close to the original location in phase space. Thus randomization of these phases is used as error mitigation strategy.

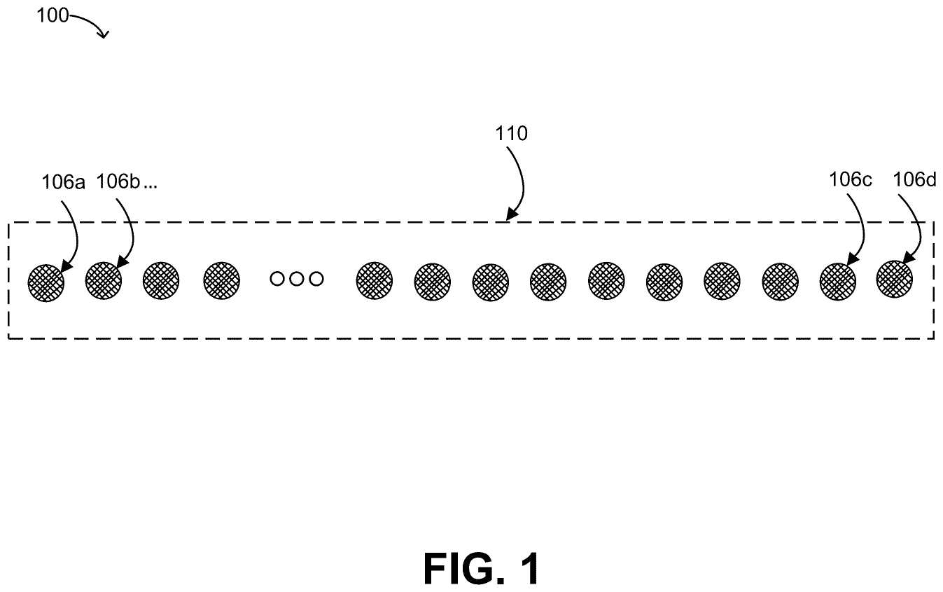

Solutions to the issues described above are explained in more detail in connection with FIGS. 1-12, with FIGS. 1-8 providing a background of QIP systems or quantum computers, and more specifically, of atomic-based QIP systems or quantum computers.

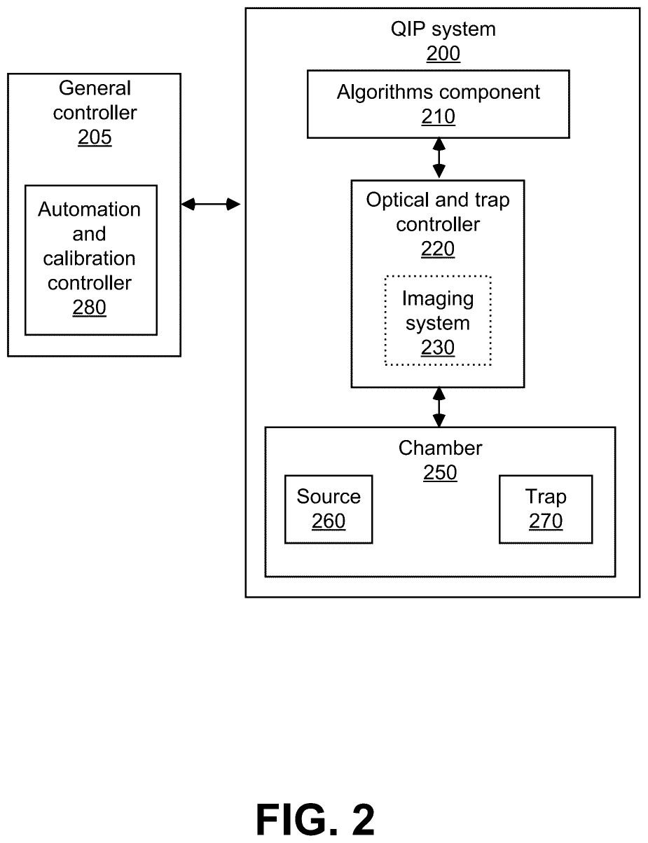

FIG. 1 illustrates a diagram 100 with multiple atomic ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ^{171Yb+} ions), for example. The ions are illuminated with laser (optical) radiation tuned to a resonance in ^{171Yb+} and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the QIP system 200 with the optical elements of a beam shaping structure as arranged therein.

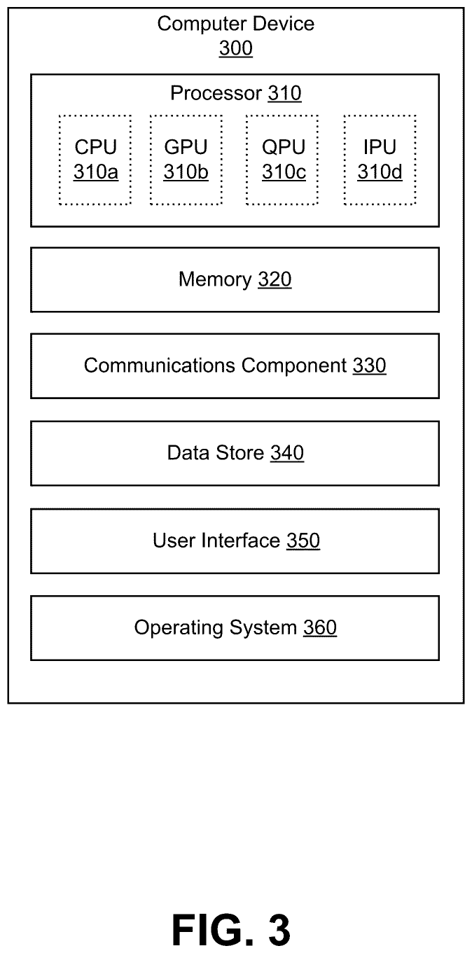

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, in one or more implementations, the QIP systems as disclosed herein include structures inserted into the QIP system that improve the efficiency of trapping ions relative to conventional trapping structures.

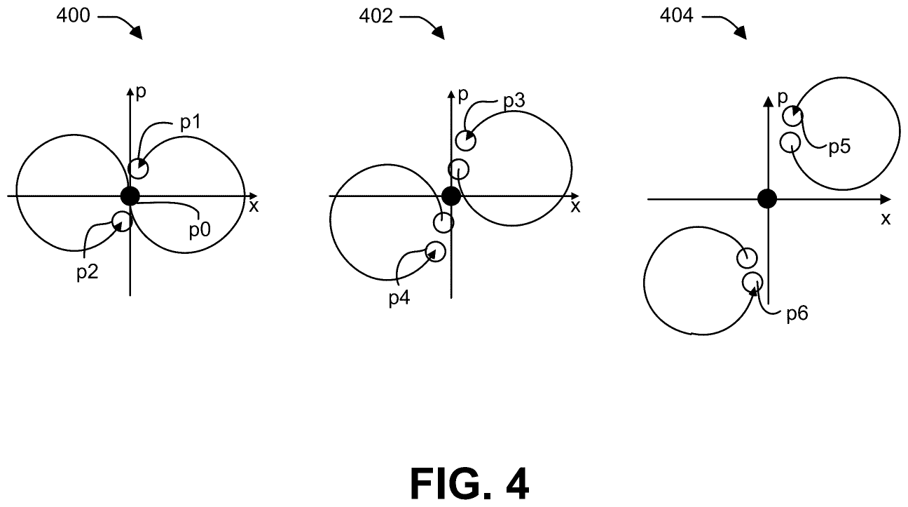

FIG. 4 illustrates phase diagrams 400, 402, and 404 illustrating residual motional excitation. The horizontal axis in each diagram represents position along a generalized spatial coordinate and the vertical axis represents momentum. Each of the phase diagrams 400, 402, and 404 shows the motional ground state of ions such as atomic ions 106 of FIG. 1. These ions are manipulated by quantum gates applied to quantum ions 106 by a quantum information processing (QIP) system such as QIP 200 of FIG. 2 or a computer system such as computer device 300 of FIG. 3. For example, the optical and trap controller 220 of FIG. 2 may be used to manipulate atomic ions 106 using quantum gates.

As mentioned previously, two qubit gates are a core building block of a quantum computer. Suppose that a quantum circuit includes three two-qubit gates in series (e.g., three CNOT gates for simplicity). Phase diagram 400 may be associated with the phase after executing the first gate, phase diagram 402 may be associated with the phase after executing the second gate, and phase diagram 404 may be associated with the phase after executing the third gate. On a basic level, executing the gates that yield the phase diagrams 400, 402, and 404 involves emitting laser pulses with the same phase onto trapped ions.

p0 represents the motional ground state of the ions. When a gate is implemented, a force is applied to the ions by laser beam(s). In an ideal scenario, consider a harmonic oscillator in which a particle is subject to a restoring force that is proportional to the displacement of the particle. If p0 is the motional ground state of the ion, the phase trajectory is depicted as a circle that begins going from all energy being in position to a combination of energy and momentum to back in position (i.e., back in the motional ground state). However, in a real-world implementation, the ion does not return to the motional ground state due to imperfect control parameters. For example, as shown in diagram 400, at the end of the first gate, the phase trajectory of the first ion ends at state p1 and the phase trajectory of the second ion ends at state p2. This signifies that the ions still have some energy and momentum and have not returned to their motional ground state.

In terms of imperfect control parameters, variations in laser beam intensity can alter the force applied to the ions, while misalignment of the laser beam may lead to inaccuracies in force application. Additionally, fluctuations in laser frequency can affect the behavior of the harmonic oscillator. Environmental noise, such as vibrations or electromagnetic interference, can also disrupt the ion's state. Furthermore, temperature variations can influence the ion's motional state and the effectiveness of the restoring force. These factors collectively prevent the ion from returning to the motional ground state as intended.

When the second gate is executed, the oscillations of the ions begin from states p1 and p2, and end at states p3 and p4, respectively. Again, because the oscillation did not return the states to the prior states p1 and p2 resulting from the first gate being implemented, there is accumulated gate error.

When the third gate is executed, the oscillations of the ions begin from states p3 and p4, and end at states p5 and p6, respectively. As can be seen, the error gets larger as additional gates are executed. More specifically, the distance between the final motional state of the ions and the ground state p0 increases after each gate. For circuits with a large number of two-qubit gates, this error can become significant. Because two-qubit gate errors can be larger if executed on a chain further away from the ground state, this leads to larger reductions in gate fidelities.

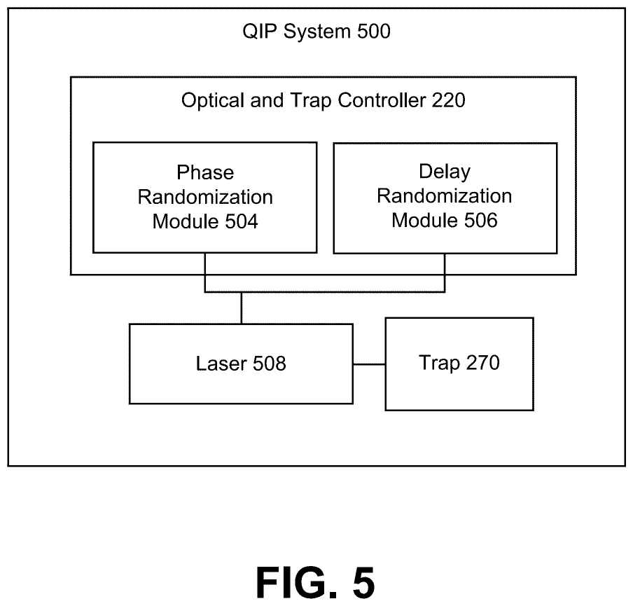

FIG. 5 illustrates a QIP system 500 executing a phase randomization module 504 and a delay randomization module 506. QIP system 500 is a variation of QIP system 200 that also includes optical and trap controller 220 and trap 270. In some aspects, modules 504 and 506 may be part of optical and trap controller 220.

Phase randomization module 504 is configured to determine a random phase value and change the current phase of a laser pulse signal from laser 508 to that random phase value. For example, for a first gate in a three gate series, laser pulse(s) of a first random phase value between 0 and 2π may be applied to ion(s), such as one or more of the ions 106a to 106d of chain 110 in trap 270, as described above. For a second gate, phase randomization module 504 may determine a second random phase value between 0 and 2π and change the first random phase value of second laser pulse(s) to the second random phase value. The second laser pulse may then be applied by laser 508 to ion(s) of trap 270. For a third gate, phase randomization module 504 may determine a third random phase value and change the second random phase value of third laser pulse(s) to the third random phase value. The third laser pulse may then be applied by laser 508 to ion(s) of trap 270.

In an aspect, the third random phase value is selected to compensate for a phase shift imparted by the second random phase value and/or the first random phase value. In an aspect, the second random phase value is selected to compensate for a phase shift imparted by the first random phase value.

In an aspect, at least two of, the third random phase value, the second random phase value, and the first random phase value are randomly selected from complimentary error-mitigating phase ranges. For example, the third random phase value may be randomly selected from a third range of phase values that is configured to reduce a phase error resulting from at least one of, a second range of phase values and a first set of phase values, respectively from which at least one the second random phase value and the first random phase value are selected. The ranges may be complimentary error-mitigating phase ranges in being of equal span and including equal magnitudes of opposing phase in the case of two gates, and including overall equal magnitudes of opposing phases in the cases in more than two gates. For example, two positive error values (e.g., 5+5) may be equal to a selected negative error value (e.g., 10) when purposefully selected, or may be selected from ranges corresponding to those values plus or minus some value (e.g., +/−10, 20, 50, 100, 1000, etc.) when randomly selected.

In some aspects, as an alternative to randomizing the phase using phase randomization module 504, optical and trap controller 220 may choose a different known phase for each gate, wherein the different phases are equally distributed around all angles. In this way the error is systematically twirled to prevent coherent addition of the error. Subsequent deviations in phase space go in different directions and may be chosen to nearly compensate for each other. For example, a first random phase value may be selected from 0 to 2π and a second random phase value may be selected from 0to −2 π. To determine the exact phase values, 2π may be divided by the number of gates. For example, if there are four gates, the deviation is π/2. Accordingly, by selecting phases such as 0, π/ 2, π, and 3π/2, the system can achieve a balanced coverage of the phase space. This strategic selection helps in twirling the errors, as each phase shift directs potential deviations in different directions, allowing them to naturally cancel each other out over multiple operations.

Phase adjustments may also be achieved by adding a delay between 0 and a full trap period (e.g., on the order of 300 nanoseconds). Delay randomization module 506 is configured to determine a random delay value (e.g., 300 nanoseconds) and wait for the random delay value to elapse before applying each subsequent laser pulse on an ion. For example, after executing the first gate, delay randomization module 506 may determine a first random delay value and wait for the first random delay value to elapse before applying subsequent laser pulse(s) associated with the second gate. After the first random delay value has elapsed, second laser pulse(s) may be applied as part of the second gate. For example, after executing the second gate, delay randomization module 506 may determine a second random delay value and wait for the second random delay value to elapse before applying subsequent laser pulse(s) associated with the third gate. After the second random delay value has elapsed, third laser pulse(s) may be applied as part of the third gate.

For instance, the first delay value may be randomly set to 150 nanoseconds. This means that after executing the first gate, the system waits for 150 nanoseconds before applying the laser pulse for the second gate. Similarly, the second delay value may be 250 nanoseconds, indicating a wait of 250 nanoseconds after the execution of the second gate before applying the laser pulse for the third gate.

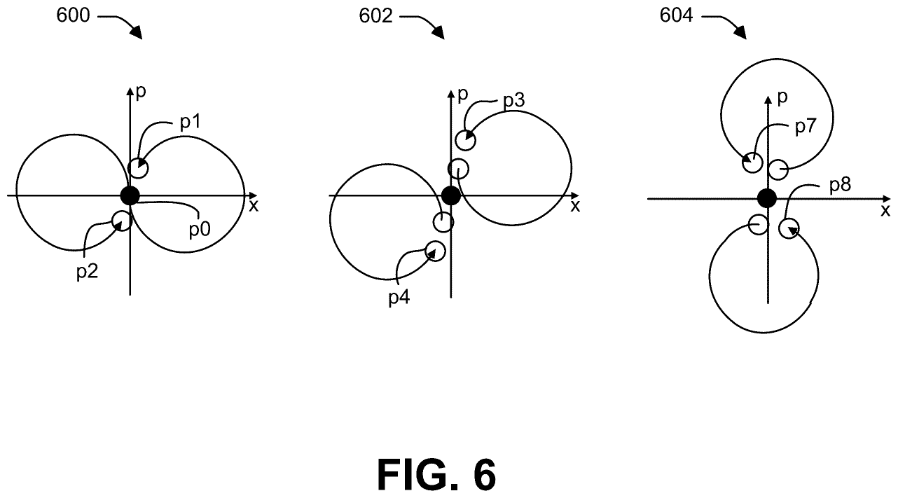

FIG. 6 illustrates phase diagrams 600, 602, and 604 illustrating residual motional excitation after applying phase randomization and/or delay randomization.

By applying laser pulses of random phases for each gate, the error accumulation along a plurality of gates becomes incoherent. Gate error is unavoidable in real world environments. Accordingly, the new “ground” state after each gate is bound to shift further away from the true ground state p0. However, randomization modules 504 and 506 prevent the error from accumulating at a rapid rate. For simplicity, phase diagram 400 matches phase diagram 600, and phase diagram 402 matches phase diagram 602. Suppose that after applying one or both of phase and time delay on the laser pulses, the phase diagrams upon executing the first gate and the second gate are phase diagrams 600 and 602, respectively.

When the third gate is executed, phase randomization module 504 may change the phase of the laser pulse(s) of the third gate to a random phase value. This random phase value leads to the phase trajectory of the ions starting from p3 and p4 moving to states p7 and p8, respectively. Likewise, if delay randomization module 506 determines a random delay value and waits for this time to elapse before applying the laser pulse(s) of the third gate, the resulting phase trajectories may also move to states p7 and p8.

Comparing phase diagram 404 with phase diagram 604, it can be seen that state p7 is closer to state p0 relative to state p5. Likewise, state p8 is closer to state p0 relative to state p6. The transition between phase diagrams 400, 402, and 404 shows nearly a linear movement away from p0. As error accumulates, and if additional gates were part of the circuit, the resulting states will continue to move away from p0. Referring to diagrams 600, 602, and 604, because of the time delays between the gates and/or the phase randomization, the error becomes random as well. If the phase is varied (either randomly or scanned around the circle) then the phase trajectory will digress slower from the initial motional state. Rather than moving further away from state p0, for example, diagram 604 depicts states p7 and p8 moving closer to p0 than states p3 and p4, respectively. If additional gates were included, the error accumulation will be incoherent (i.e., randomized and not linearly moving away from the true ground state p0). The use of phase randomization and time delay randomization is especially useful when dealing with circuits with a large number of gates. Mathematically, this would be the difference between a directed walk in one direction where the separation from the initial state is linear in the number of steps, to a random walk where the separation from the initial state grows only as the square root of the number of steps. In one or more aspects, the selected random values are constrained to a set of known values. In one or more aspects, the selected random values are selected to correspond to known values representative of error values that are preferably statistically less than expected error values that accumulate through two or more gates.

There are approaches to cancelling residual motional excitation using a compensated pulse scheme. However, such schemes have large overheads in longer gate duration and higher spontaneous emission. The phase randomization and time delay randomization described in the present disclosure ensures that these motional excitations cannot coherently add without such large overheads.

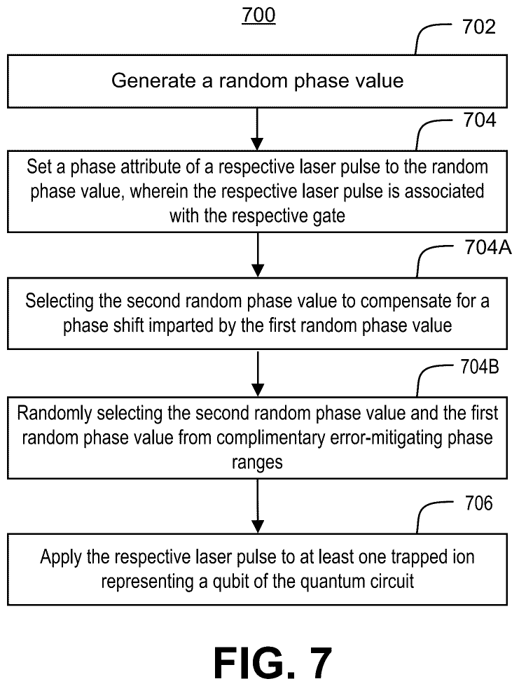

FIG. 7 illustrates a method 700 for minimizing error accumulation associated with residual motional excitation in a quantum circuit. The steps of method 700 are applied to each respective gate in a quantum circuit. In some aspects, the respective gate is a two-qubit gate. At 702, optical and trap controller 220 generates a random phase value. At 704, optical and trap controller 220 sets a phase attribute of a respective laser pulse to the random phase value. Here, the respective laser pulse is associated with the respective gate. In an aspect, step 704 may include at least one of steps 704A and 704B. At 704A, optical and trap controller 220 randomly selects the second random phase value to compensate for a phase shift imparted by the first random phase value. At 704B, optical and trap controller 220 randomly selects the second random phase value and the first random phase value from complimentary error-mitigating phase ranges. In an aspect, phase values are randomly selected from a constrained set(s) of values. In an aspect, the sets may include the same or different phase magnitude values of the same or different signs (polarities). In an aspect, the sets are selected and configured to compliment each other to reduce the accumulating error between sequential or even non-sequential gates depends on their values (e.g., phase magnitudes and signs).

At 706, optical and trap controller 220 applies the respective laser pulse to at least one trapped ion representing a qubit of the quantum circuit.

For example, optical and trap controller 220 may set a first random phase value as a phase attribute of the respective laser pulse for a first gate of the quantum circuit and may set a second random phase value as a phase attribute of another respective laser pulse for a second gate of the quantum circuit. In some aspects, the first random phase value is different from the second random phase value.

In some aspects, optical and trap controller 220 may apply the respective laser pulse to the at least one trapped ion when executing the first gate, and may apply the another respective laser pulse to the at least one trapped ion when executing the second gate.

In some aspects, the random phase value is within a threshold phase boundary.

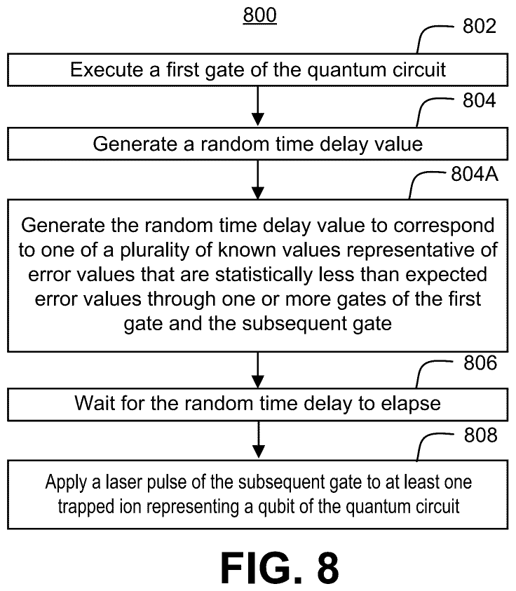

FIG. 8 illustrates a method 800 for minimizing error accumulation associated with residual motional excitation in a quantum circuit using time delay(s). The steps of method 800 are applied to each respective gate in a quantum circuit. At 802, optical and trap controller 220 executes a first gate of the quantum circuit. At 804, optical and trap controller 220 generates a random time delay value. In an aspect, step 804 may include step 804A. At block 804A, the optical and trap controller 220 generates the random time delay value to correspond to one of a plurality of known values representative of error values that are statistically less than expected error values through one or more gates of the first gate and the subsequent gate. At 806, optical and trap controller 220 waits for the random time delay to elapse. At 808, optical and trap controller 220 applies a laser pulse of the subsequent gate to at least one trapped ion representing a qubit of the quantum circuit.

In one or more aspects, the generated random time delays are constrained to a set of known random time delays. In one or more aspects, the generated random time delays are selected to correspond to known values representative of error values that are preferably statistically less than expected error values that accumulate through two or more gates.

In some aspects, the random time delay value is within a threshold time delay boundary.

Clause 1. A method for minimizing error accumulation in a quantum circuit, the method comprising: for at least one respective gate in the quantum circuit: generating a random phase value; setting a phase attribute of a respective laser pulse to the random phase value, wherein the respective laser pulse is associated with the respective gate; and applying the respective laser pulse to at least one trapped ion representing a qubit of the quantum circuit.

Clause 2. The method of clause 1, wherein a first random phase value is set as a phase attribute of the respective laser pulse for a first gate of the quantum circuit and a second random phase value is set as a phase attribute of another respective laser pulse for a second gate of the quantum circuit.

Clause 3. The method of any preceding clauses, further comprising: applying the respective laser pulse to the at least one trapped ion when executing the first gate; and applying the another respective laser pulse to the at least one trapped ion when executing the second gate.

Clause 4. The method of any preceding clauses, wherein the first random phase value is different from the second random phase value.

Clause 5. The method of any preceding clauses, further comprising selecting the second random phase value to compensate for a phase shift imparted by the first random phase value.

Clause 6. The method of any preceding clauses, further comprising randomly selecting the second random phase value and the first random phase value from complimentary error-mitigating phase ranges.

Clause 7. The method of any preceding clauses, wherein the respective gate is a two-qubit gate.

Clause 8. The method of any preceding clauses, wherein the random phase value is within a threshold phase boundary.

Clause 9. A method for minimizing error accumulation in a quantum circuit, the method comprising: executing a first gate of the quantum circuit; and for each subsequent gate in the quantum circuit: generating a random time delay value; waiting for the random time delay to elapse; and applying a laser pulse of the subsequent gate to at least one trapped ion representing a qubit of the quantum circuit.

Clause 10. The method of clause 9, wherein the random time delay value is within a threshold time delay boundary.

Clause 11. The method of any preceding clauses, further comprising generating the random time delay value to correspond to one of a plurality of known values representative of error values that are statistically less than expected error values through one or more gates of the first gate and the each subsequent gate.

Clause 12. A quantum information processing (QIP) system for minimizing error accumulation in a quantum circuit, the system comprising: a laser configured to generate a laser pulse; and a hardware processor configured to: for at least one respective gate in the quantum circuit: generate a random phase value; set a phase attribute of a respective laser pulse generated by the laser to the random phase value, wherein the respective laser pulse is associated with the at least one respective gate; and apply the respective laser pulse to at least one trapped ion representing a qubit of the quantum circuit.

Clause 13. The QIP system of clause 12, wherein a first random phase value is set as a phase attribute of the respective laser pulse for a first gate of the quantum circuit and a second random phase value is set as a phase attribute of another respective laser pulse for a second gate of the quantum circuit.

Clause 14. The QIP system of any preceding clauses, wherein the hardware processor is configured to: apply the respective laser pulse to the at least one trapped ion when executing the first gate; and apply the another respective laser pulse to the at least one trapped ion when executing the second gate.

Clause 15. The QIP system of any preceding clauses, wherein the first random phase value is different from the second random phase value.

Clause 16. The QIP system of any preceding clauses, wherein the second random phase value is selected to compensate for a phase shift imparted by the first random phase value.

Clause 17. The QIP system of any preceding clauses, wherein the second random phase value and the first random phase value are randomly selected from complimentary error-mitigating phase ranges.

Clause 18. The QIP system of any preceding clauses, wherein the respective gate is a two-qubit gate.

Clause 19. The QIP system of any preceding clauses, wherein the random phase value is within a threshold phase boundary.

Clause 20. A quantum information processing (QIP) system for minimizing error accumulation in a quantum circuit, the system comprising: a laser configured to generate a laser pulse; and a hardware processor configured to: execute a first gate of the quantum circuit; and for each subsequent gate in the quantum circuit: generate a random time delay value; wait for the random time delay to elapse; and apply, by the laser, a laser pulse of the subsequent gate to at least one trapped ion representing a qubit of the quantum circuit.

Clause 21. The QIP system of clause 20, wherein the random time delay value is within a threshold time delay boundary.

Clause 22. The QIP system of any preceding clauses, wherein the generated random time delay value is generated to correspond to one of a plurality of known values representative of error values that are statistically less than expected error values through one or more gates of the first gate and the subsequent gate.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method for minimizing error accumulation in a quantum circuit, the method comprising:
for at least one respective gate in the quantum circuit:
generating a random phase value;
setting a phase attribute of a respective laser pulse to the random phase value,
wherein the respective laser pulse is associated with the at least one respective gate; and
applying the respective laser pulse to at least one trapped ion representing a qubit of the quantum circuit.

2. The method of claim 1, wherein a first random phase value is set as a phase attribute of the respective laser pulse for a first gate of the quantum circuit and a second random phase value is set as a phase attribute of another respective laser pulse for a second gate of the quantum circuit.

3. The method of claim 2, further comprising:
applying the respective laser pulse to the at least one trapped ion when executing the first gate; and
applying the another respective laser pulse to the at least one trapped ion when executing the second gate.

4. The method of claim 2, wherein the first random phase value is different from the second random phase value.

5. The method of claim 2, further comprising selecting the second random phase value to compensate for a phase shift imparted by the first random phase value.

6. The method of claim 2, further comprising randomly selecting the second random phase value and the first random phase value from complimentary error-mitigating phase ranges.

7. The method of claim 1, wherein the at least one gate is a two-qubit gate.

8. The method of claim 1, wherein the random phase value is within a threshold phase boundary.

9. A method for minimizing error accumulation in a quantum circuit, the method comprising:
executing a first gate of the quantum circuit; and
for each subsequent gate in the quantum circuit:
generating a random time delay value;
waiting for the random time delay to elapse; and
applying a laser pulse of the subsequent gate to at least one trapped ion
representing a qubit of the quantum circuit.

10. The method of claim 9, wherein the random time delay value is within a threshold time delay boundary.

11. The method of claim 9, further comprising generating the random time delay value to correspond to one of a plurality of known values representative of error values that are statistically less than expected error values through one or more gates of the first gate and the each subsequent gate.

12. A quantum information processing (QIP) system for minimizing error accumulation in a quantum circuit, the system comprising:
a laser configured to generate a laser pulse; and
a hardware processor configured to:
for at least one respective gate in the quantum circuit:
generate a random phase value;
set a phase attribute of a respective laser pulse generated by the laser to the random phase value, wherein the respective laser pulse is associated with the at least one respective gate; and
apply the respective laser pulse to at least one trapped ion representing a qubit of the quantum circuit.

13. The QIP system of claim 12, wherein a first random phase value is set as a phase attribute of the respective laser pulse for a first gate of the quantum circuit and a second random phase value is set as a phase attribute of another respective laser pulse for a second gate of the quantum circuit.

14. The QIP system of claim 13, wherein the hardware processor is configured to:
apply the respective laser pulse to the at least one trapped ion when executing the first gate; and
apply the another respective laser pulse to the at least one trapped ion when executing the second gate.

15. The QIP system of claim 13, wherein the first random phase value is different from the second random phase value.

16. The QIP system of claim 13, wherein the second random phase value is selected to compensate for a phase shift imparted by the first random phase value.

17. The QIP system of claim 13, wherein the second random phase value and the first random phase value are randomly selected from complimentary error-mitigating phase ranges.

18. The QIP system of claim 12, wherein the respective gate is a two-qubit gate.

19. The QIP system of claim 12, wherein the random phase value is within a threshold phase boundary.

20. A quantum information processing (QIP) system for minimizing error accumulation in a quantum circuit, the system comprising:
a laser configured to generate a laser pulse; and
a hardware processor configured to:
execute a first gate of the quantum circuit; and
for each subsequent gate in the quantum circuit:
generate a random time delay value;
wait for the random time delay to elapse; and
apply, by the laser, a laser pulse of the subsequent gate to at least one
trapped ion representing a qubit of the quantum circuit.

21. The QIP system of claim 20, wherein the random time delay value is within a threshold time delay boundary.

22. The QIP system of claim 20, wherein the generated random time delay value is generated to correspond to one of a plurality of known values representative of error values that are statistically less than expected error values through one or more gates of the first gate and the subsequent gate.
